(19) United States
(12) Patent Application Publication
(10) Pub. No.: US 2022/0333355 A1
(43) Pub. Date: Oct. 20, 2022

(54) CONTROL SYSTEM OF CONSTRUCTION MACHINERY AND METHOD OF PROVIDING WORKING GUIDE LINE

(71) Applicant: HYUNDAI DOOSAN INFRACORE CO., LTD., Dong-gu (KR)

(72) Inventors: Heongsik Um, Dong-gu (KR); Junhyun Jang, Dong-gu (KR); Gijung Yun, Dong-gu (KR)

(21) Appl. No.: 17/715,397

(22) Filed: Apr. 7, 2022

(30) Foreign Application Priority Data
Apr. 7, 2021 (KR) 10-2021-0045155

(51) Int. Cl. E02F 9/26; E02F 9/20; G05D 1/00; G06T 7/73; G06T 11/20

(52) U.S. Cl. CPC E02F 9/261; E02F 9/264; E02F 9/205; G05D 1/0038; G06T 7/73; G06T 11/20; G05D 2201/0202; G06T 2207/10028; G06T 2207/20081; G06T 2207/30252

(57) ABSTRACT

A control system for construction machinery includes 3D camera configured to recognize an object located around construction machinery and capture an image, a position information receiving device configured to obtain a reference coordinate corresponding to a position of the construction machinery, a data processing device configured to obtain a relative coordinate of the object relative to the construction machinery from the image and convert the relative coordinate based on the reference coordinate to obtain a three-dimensional coordinate, and a control device configured to display the image having the three-dimensional coordinate on a screen.

### CROSS-REFERENCE TO RELATED APPLICATIONS

This application claims priority under 35 U.S.C. § 119 to Korean Patent Application No. 10-2021-0045155, filed on Apr. 7, 2021 in the Korean Intellectual Property Office (KIPO), the contents of which are herein incorporated by reference in their entirety.

### BACKGROUND

Example embodiments relate to a control system of construction machinery and a method of providing a working guide line. More particularly, example embodiments relate to a control system of construction machinery for controlling an excavator and a method of providing a working guide line of the construction machinery.

A guide line recognition process such as a surveying process may be necessary for construction machinery to work accurately at a construction site. The guide line recognition process is usually performed by indicating a work area through a method of installing guide lines at the construction site based on manual surveying. In particular, in case of an excavator, a more sophisticated guide line recognition process may be required for a precise excavation work. Recently, 3D machine control technology has been introduced, and precise excavation work may be possible without a separate surveying process. However, since the 3D machine control technology requires input of design drawing data in advance, and shows only the drawing and the shape of the excavator through a separate display, there may be limits to improving the working speed.

### SUMMARY

Example embodiments provide a control system for construction machinery capable of recognizing a surrounding space of the construction machinery.

Example embodiments provide a working guide line recognition method for construction machinery capable of recognizing a surrounding space of the construction machinery.

According to example embodiments, a control system for construction machinery includes a 3D camera configured to recognize an object located around the construction machinery and capture an image of the object, a position information receiving device configured to obtain a reference coordinate corresponding to a position of the construction machinery, a data processing device configured to recognize the relative coordinate of the object relative to the construction machinery from the image and convert the relative coordinate based on the reference coordinate to obtain a three-dimensional coordinate, and a control device configured to display the image having the three-dimensional coordinates on a screen.

In example embodiments, the data processing device may include an image recognition module configured to extract the relative coordinate of the object from the image, and a coordinate conversion module configured to coordinate-transform the relative coordinate of the object based on the reference coordinate to obtain the three-dimensional coordinate.

In example embodiments, the coordinate conversion module may obtain a corrected relative coordinate through axis transformation of the relative coordinate, the axis transformation reflecting rotation angles for X-axis, Y-axis, and Z-axis of the construction machinery, and may convert the corrected relative coordinates into an absolute coordinate to obtain the three-dimensional coordinate.

In example embodiments, the construction machinery may be an excavator.

In example embodiments, the data processing device may add distance data for a maximum working radius of the excavator to the three-dimensional coordinates, and the control device may display the distance data on the screen.

In example embodiments, the control device may display design drawing data of a construction site in association with the three-dimensional coordinate on the screen.

In example embodiments, the data processing device may extract a three-dimensional structure or a guide line installed for manual surveying from the image, and the control device interlocks the extracted three-dimensional structure or guide line installed for the manual surveying with the design drawing data.

In example embodiments, the image recognition module may include an image determiner configured to classify the image and store the image as a data set and recognize the object in the image using an algorithm previously learned from the data set.

In example embodiments, the image determiner may extract a three-dimensional structure or a guide line installed for manual surveying as a feature point from the data set.

According to example embodiments, a control system for construction machinery includes a 3D camera configured to recognize an object located around the construction machinery and capture an image of the object, and an image recognition module configured to extract a relative coordinate of the object from the image. The image recognition module includes an image determiner configured to classify the image and store the image as a data set and recognize the object in the image using an algorithm previously learned from the data set, and the image determiner extracts a three-dimensional structure or a guide line installed for manual surveying as a feature point from the data set.

According to example embodiments, in a method of providing a working guide line for construction machinery, an object located around the construction machinery is recognized and an image is obtained through a 3D camera. A reference coordinate corresponding to a position of the construction machinery is obtained through a position information receiving device. A relative coordinate of the object relative to the construction machinery is obtained from the image. The relative coordinates is converted based on the reference coordinates to obtain a three-dimensional coordinate. The image having the three-dimensional coordinate is displayed on the screen.

In example embodiments, the method may further include obtaining a corrected relative coordinate through axis transformation of the relative coordinate, the axis transformation reflecting rotation angles for X-axis, Y-axis, and Z-axis of the construction machinery, and obtaining the three-dimensional coordinate may include converting the corrected relative coordinate into an absolute coordinate based on the reference coordinate.

In example embodiments, the construction machinery may be an excavator.

In example embodiments, the method may further include adding distance data for a maximum working radius of the excavator to the three-dimensional coordinate, and displaying the image on the screen may include displaying the image including the distance data on the screen.

In example embodiments, the method may further include displaying design drawing data of a construction site in association with the three-dimensional coordinate on the screen.

In example embodiments, obtaining the relative coordinates may include classifying the image and storing the image as a data set and recognizing the object in the image using an algorithm previously learned from the data set.

In example embodiments, obtaining the relative coordinates may further include extracting a three-dimensional structure or a guide line installed for manual surveying as a feature point from the data set.

According to example embodiments, a control system for construction machinery may include a 3D camera configured to recognize an object located around the construction machinery and capture an image of the object, a position information receiving device configured to obtain a reference coordinate corresponding to a position of the construction machinery, a data processing device configured to obtain a relative coordinate of the object relative to the construction machinery from the image and to convert the relative coordinate based on the reference coordinate to obtain a three-dimensional coordinate, and a control device configured to display the image having the three-dimensional coordinate on a screen.

Accordingly, the control system may recognize the relative coordinate for a surrounding space by capturing the image of the construction machinery by using the 3D camera, the control system may obtain relative coordinate data for the surrounding space of the construction machinery, the control system may acquire absolute coordinate data for the position of the construction machinery through the position information receiving device, and reflect absolute coordinate data in the relative coordinate data to acquire 3D image data. By using the obtained 3D image data, it may be possible to interwork with the control device such as machine guidance or machine control, and it may be possible to enable more precise and accurate construction work.

However, the effect of the inventive concept may not be limited thereto, and may be expanded without being deviated from the concept and the scope of the present disclosure.

### BRIEF DESCRIPTION OF THE DRAWINGS

Example embodiments will be more clearly understood from the following detailed description taken in conjunction with the accompanying drawings.

FIG. 1 is a side view illustrating construction machinery in accordance with example embodiments.

FIG. 2 is a block diagram illustrating a control system for construction machinery in accordance with example embodiments.

FIG. 3 is a view illustrating a surrounding area of construction machinery recognized by a 3D camera in FIG. 2.

FIG. 4 is a view illustrating a method of setting plane coordinates for an image obtained from a 3D camera by the image recognition module in FIG. 2.

FIG. 5 is a view illustrating a method of setting relative coordinates for a surrounding space of construction machinery by the image recognition module in FIG. 2.

FIG. 6 is a view illustrating a working radius on a plane according to a distance to the construction machinery set by the image recognition module in FIG. 2.

FIG. 7 is a view illustrating a working radius in space according to a distance to the construction machinery set by the image recognition module in FIG. 2.

FIG. 8 is a view illustrating an axis conversion correction for construction machinery performed by the coordinate conversion module in FIG. 2.

FIG. 9A is view illustrating a screen of a display device that displays an image for three-dimensional coordinates converted by the coordinate conversion module in FIG. 2.

FIG. 9B is view illustrating a screen of a display device that displays an image for a three dimensional structure and a guide line with a design drawing data.

FIG. 10 is a flow chart illustrating a method of providing a working guide lines for construction machinery in accordance with example embodiments.

### DETAILED DESCRIPTION

Hereinafter, preferable embodiments of the present disclosure will be explained in detail with reference to the accompanying drawings.

In the drawings, the sizes and relative sizes of components or elements may be exaggerated for clarity.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example embodiments may, however, be embodied in many different forms and should not be construed as limited to example embodiments set forth herein. Rather, these example embodiments are provided so that this disclosure will be thorough and complete, and will fully convey the scope of example embodiments to those skilled in the art.

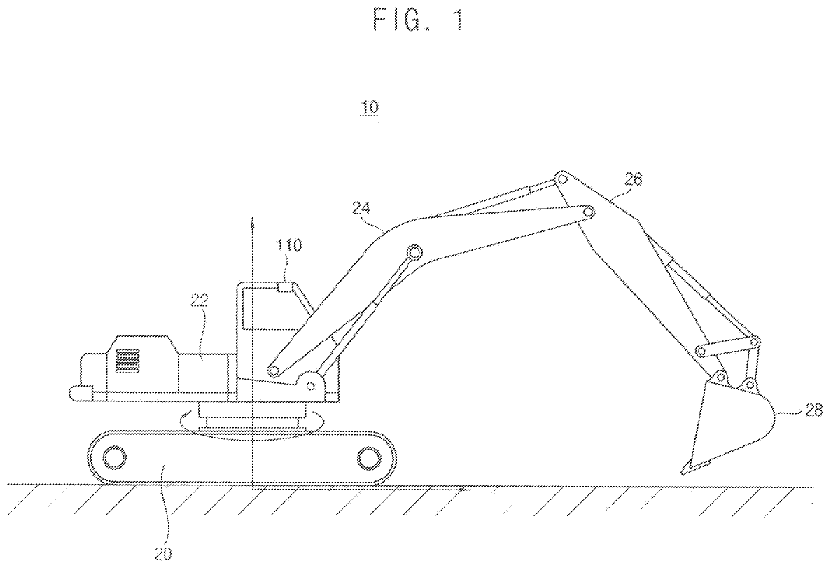

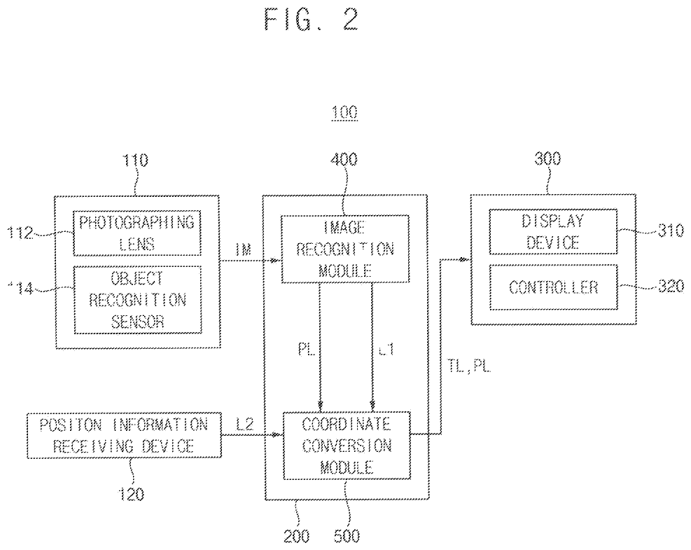

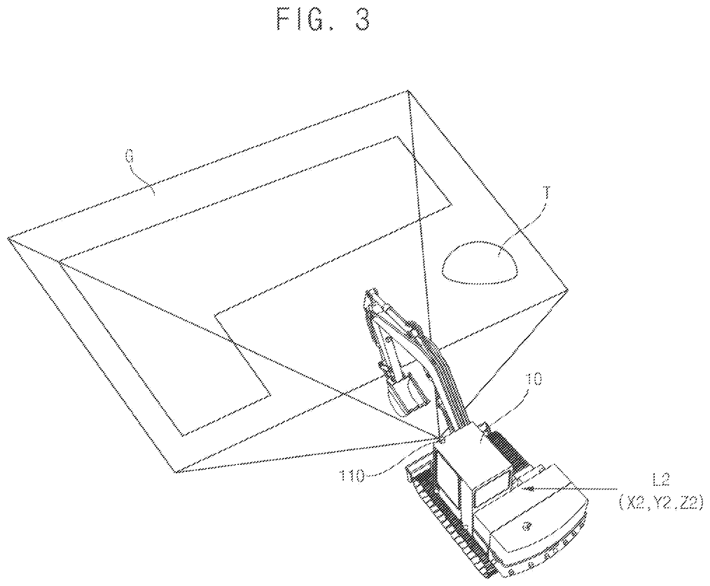

FIG. 1 is a side view illustrating construction machinery in accordance with example embodiments. FIG. 2 is a block diagram illustrating a control system for construction machinery in accordance with example embodiments. FIG. 3 is a view illustrating a surrounding area of construction machinery recognized by a 3D camera in FIG. 2.

Referring to FIGS. 1 to 3, a control system 100 of construction machinery may include a 3D camera 110, a position information receiving device 120, a data processing device 200 and a control device 300. The data processing device 200 may include an image recognition module 400 and a coordinate conversion module 500.

In example embodiments, the control system 100 may be a space recognition control system that recognizes a surrounding space of construction machinery 10 and simultaneously provides a 3D image of the surrounding space to an operator. The control system 100 may serve as a machine guidance system that provides 3D image information about a working area in the surrounding space to the operator. In addition, the control system 100 may serve as a machine control system of the construction machinery 10 to precisely control a bucket 28 of a front work apparatus so as not to exceed the working area.

As illustrated in FIG. 1, in example embodiments, in case that the construction machinery 10 is an excavator, the excavator may include a lower traveling body 20 having a caterpillar track to move the entire excavator and an upper swinging body 22 rotatably provided on the lower traveling body 20. The upper swinging body 22 may include the front work apparatus having a boom 24, an arm 26 and the bucket 28.

In example embodiments, the 3D camera 110 may be installed on the upper swinging body 22 toward a front of the excavator. The 3D camera 110 may photograph an object located around the excavator to provide 3D information.

The 3D camera 110 may include a photographing lens 112. Additionally, the 3D camera 110 may further include an object recognition sensor 114. For example, the 3D camera 110 may be positioned toward the front of the excavator corresponding to a working radius.

As illustrated in FIG. 3, the 3D camera 110 may recognize a space for an object T or the surrounding space G located around the excavator by using a method of measuring a distance from the 3D camera 110 or the excavator to the object T or the surrounding space G.

For example, the 3D camera 110 may include a stereo vision camera. A difference between central axis positions of two-dimensional left/right images input through left/right lenses of the stereo vision camera located adjacent to each other may be calculated by using a stereo vision system implemented by CPU, GPU, hardware acceleration, etc., to acquire 3D distance information.

The stereo vision camera may include a parallel type, an orthogonal type, a horizontal type, a cross type, and a horizontal movement type according to an arrangement of left and right cameras. A distance between the left and right lenses of the stereo vision camera may be within a range of 5 cm to 8 cm. The stereo vision camera may be able to change an illuminance according to a surrounding environment.

The photographing lens 112 may photograph a surrounding image of the excavator. When the stereo vision camera is used, the photographing lens may include left/right lenses closely located. When the 3D camera 110 includes the stereo vision camera, the photographing lens 112 may include the left and right lenses closely located each other. Alternatively, the photographing lens 112 may include an optical lens capable of photographing up to a blind area by refracting light.

The object recognition sensor 114 may be a sensor that measures a distance using light to detect an object. The object recognition sensor 114 may include a RADAR (Radio Detecting And Ranging) sensor or a LIDAR (Light Detection And Ranging) sensor. The radar sensor may recognize a distance, a direction, etc. by using electromagnetic waves that are emitted and re-received. The LIDAR sensor may increase precision and resolution by emitting a pulse laser having a short wavelength.

In example embodiments, the position information receiving device 120 may acquire position information of the excavator. The position of the excavator acquired by the position information receiving device 120 may be referred to as a reference coordinate L2.

For example, the position information receiving device 120 may include a receiver of a Global Navigation Satellite System (GNSS). The global navigation satellite system may be a series of systems for locating a target and providing visual information using a plurality of artificial satellites and receiving equipment on a ground. The global navigation satellite system may use a Differential Global Navigation Satellite System (DGNSS) method that improves positioning accuracy by receiving correction information for each artificial satellite from a reference station and correcting a positioning error at a user's position. For example, the position information receiving device 120 may include a Global Positioning System (GPS), a GLObal Navigation Satellite System (GLONASS), Galileo, Beidou, etc.

In example embodiments, the data processing device 200 and the control device 300 may be mounted on the upper swinging body 22 as a part of a vehicle control unit (VCU) or as a separate controller. The data processing device 200 and the control device 300 may be provided separately or integrally with a machine guidance device or a machine control device. The data processing device 200 and the control device 300 may include designated hardware, software, and circuitry for performing functions described herein. These components may be physically implemented by electrical circuits such as logic circuits, microprocessors, memory devices, and the like.

In example embodiments, the image recognition module 400 of the data processing device 200 may include an image determiner. The image determiner may analyze and learn an image captured by the 3D camera 110. The data processing device 200 may analyze and learn the image through deep learning by the image determiner.

In particular, the image determiner may classify the image, and store the image as a data set. The data set may be an image data sample for learning an object from the image through the deep learning. The data set may be classified and stored as image contents captured according to an angle of the upper swinging body 22 of the construction machinery 10, an angle of the 3D camera 110, and the like.

In example embodiments, the data processing device 200 may extract a feature point (keypoint) from the data set through the image determiner using a semantic segmentation based on the deep learning. The semantic segmentation may be to classify the object existing in the image by pixel. The semantic segmentation may label which class each pixel in the image corresponds to. The feature point may mean pixels of the object that can be a feature of the image except for an unnecessary background. The feature point may be pixels of the object characterized by excluding the unnecessary background in the image.

The data processing device 200 may recognize the object in the image through the feature point. Specifically, the data processing device 200 may extract same feature points from a plurality of 2D images constituting the image, and recognize the object having the same feature points as the same object. The data processing device 200 may classify the feature point by labeling it according to the object.

In example embodiments, the data processing device 200 may extract a three-dimensional structure or a guide line installed for manual surveying as the feature point through the image determiner. The image determiner may label and classify the feature points for the three-dimensional structure or the guide line. As will be described later, the data processing device 200 may set a relative coordinate for the three-dimensional structure or the guide line through the feature point extracted from the image.

The control device 300 may include a display device 310 and a controller 320. The display device 310 may be installed on a driver's seat located on the upper swinging body 22 of the excavator to display information. The control device controller 320 may be installed in the upper swinging body 22 to control a movement of the excavator.

In example embodiments, the control device 300 may perform a machine guidance function or a machine control function. The machine guidance may provide information including a condition of the excavator, a manipulation method of the excavator, a set working range, a danger zone, etc., to the driver, thereby guiding the driver's operation of the excavator or checking a work progress. The machine control may support the driver's operation convenience or prevent safety accidents caused by operation mistakes through active control that includes changing a posture of a work device for tasks repeated within certain conditions or set working ranges or a specific task, automatic stopping or avoidance driving when entering a hazardous area or foreseeing a vehicle overturning, limiting the excavator operation so as not to deviate from the set working range, etc.

The control device 300 may receive a three-dimensional coordinate TL and a plane coordinate PL obtained through the image recognition module 400 and the coordinate conversion module 500 of the data processing device 200. As will be described later, the three-dimensional coordinate TL (x3, y3, z3) may refer to an absolute coordinate into which the relative coordinate L1 (x1, y1, z1) is converted based on the reference coordinate L2 (x2, y2, z2). The relative coordinate L1 (x1, y1, z1) may correspond to a position of the object located around the construction machine 10 that is photographed by the 3D camera 110. The reference coordinate L2 (x2, y2, z2) may correspond to a position of the construction machinery 10 that is obtained by the position information receiving device 120.

The control device 300 may display a 3D image having the three-dimensional coordinates TL on a screen such as a monitor through the display device 310. The control device 300 may control the operation of the excavator through the controller 320 using geographic coordinate information including the three-dimensional coordinates TL.

In example embodiments, the control device 300 may link the three-dimensional coordinates TL with design drawing data input from an outside. The control device 300 may link the three-dimensional structure or the guide line installed for the manual surveying with the design drawing data. The design drawing data may include work contents, a work area, a survey point, specific dimensions, necessary materials, and the like of an excavator, which are used at a construction site. The control device 300 may display the three-dimensional structure or the guide line linked with the design drawing data through the display device 310.

For example, when the control device 300 performs the machine guidance function, the control device 300 may display the image having the three-dimensional coordinates TL on the screen through the display device 310. In addition, when the excavator deviates from predetermined coordinates (e.g., the working area), the control device 300 may provide information to the driver by sending a warning signal or displaying it on the screen. Alternatively, when the control device 300 performs the machine control function, the control device 300 may control the excavator so as not to exceed the working radius defined by predetermined coordinates, thereby increasing a precision of a work of the excavator.

Hereinafter, the data processing device 200 will be explained in detail.

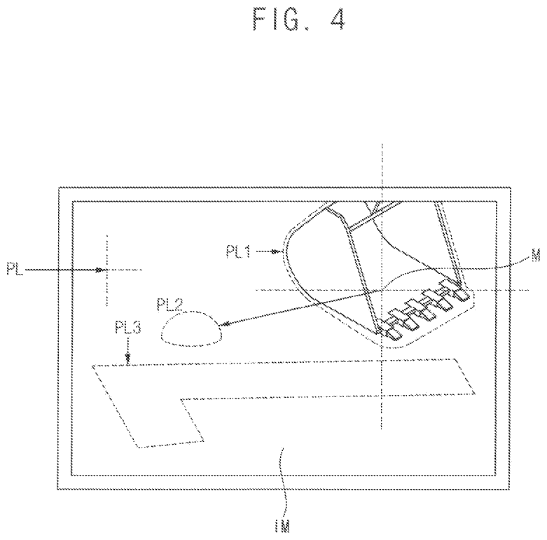

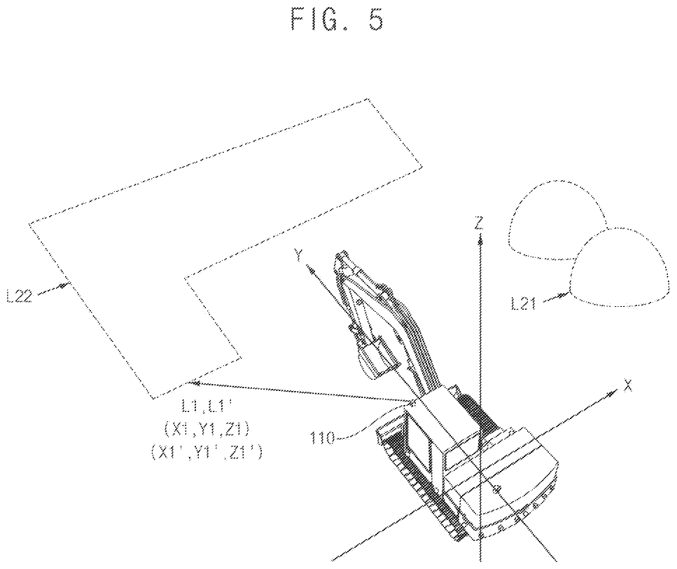

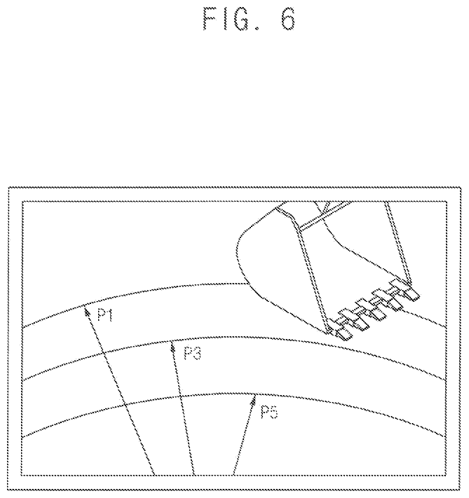

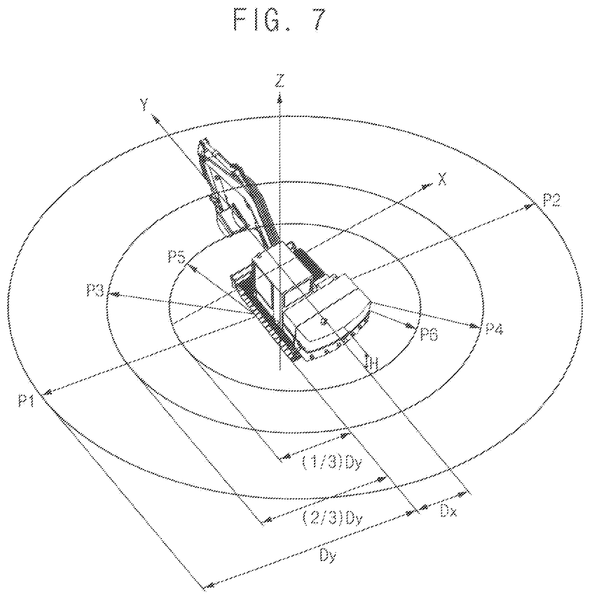

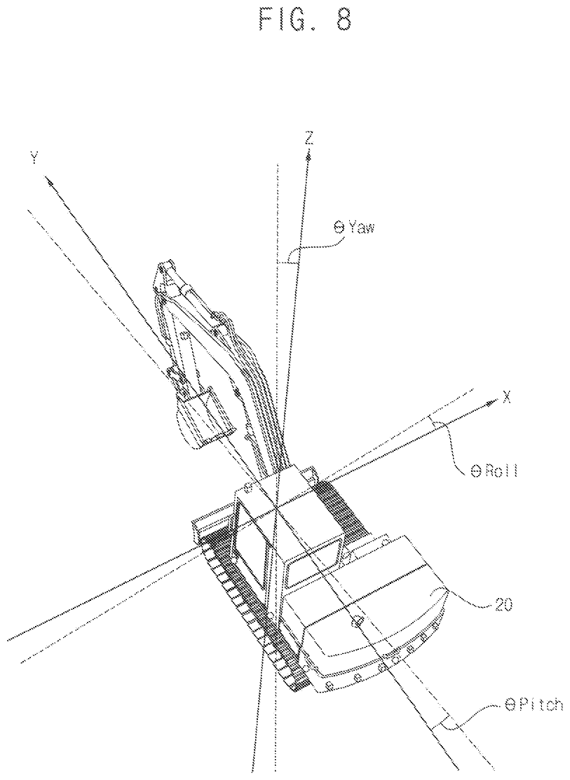

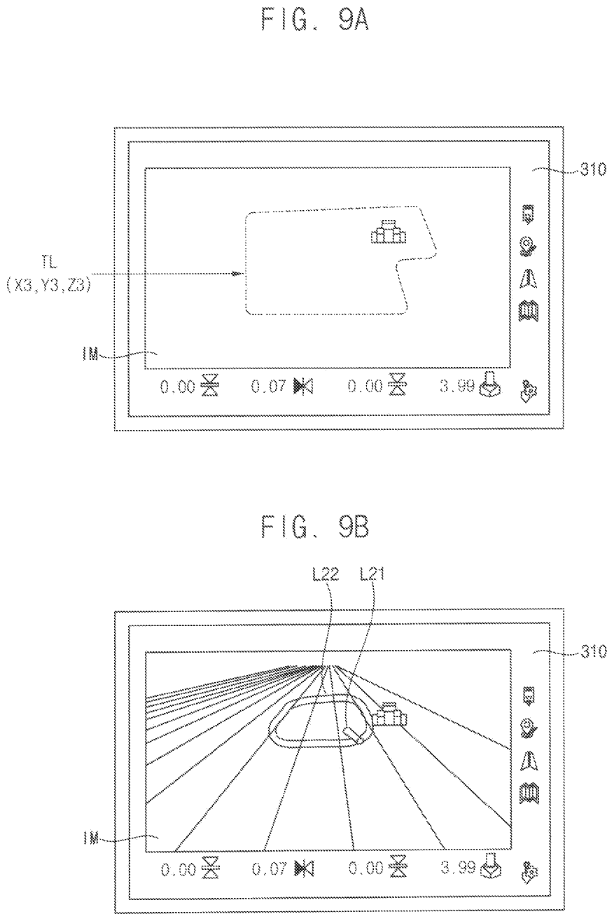

FIG. 4 is a view illustrating a method of setting plane coordinates for an image obtained from a 3D camera by the image recognition module in FIG. 2. FIG. 5 is a view illustrating a method of setting relative coordinates for a surrounding space of construction machinery by the image recognition module in FIG. 2. FIG. 6 is a view illustrating a working radius on a plane according to a distance to the construction machinery set by the image recognition module in FIG. 2. FIG. 7 is a view illustrating a working radius in space according to a distance to the construction machinery set by the image recognition module in FIG. 2. FIG. 8 is a view illustrating an axis conversion correction for construction machinery performed by the coordinate conversion module in FIG. 2. FIG. 9A is a view illustrating a screen of a display device that displays an image for three-dimensional coordinates converted by the coordinate conversion module in FIG. 2. FIG. 9B is view illustrating a screen of a display device that displays an image for a three dimensional structure and a guide line with a design drawing data.

Referring to FIGS. 4 to 9, a control system 100 of construction machinery may recognize a relative coordinate L1 of the object located around an excavator through an image recognition module 400, and may acquire a three-dimensional coordinate TL coordinate-transformed by converting a relative coordinates L1 based on a reference coordinate L2 through a coordinate conversion module 500.

As illustrated in FIG. 4, the image recognition module 400 may set 2D coordinates for the image IM around the excavator photographed through the 3D camera 110. 2D coordinates obtained from the image IM captured by the 3D camera 110 may be defined as plane coordinates PL. For example, the image recognition module 400 may recognize a color or shape of a 2D image captured by the 3D camera 110 and automatically set the plane coordinates PL based on a specific position or a reference position. Alternatively, the plane coordinates PL may be manually input or may be set as a specific position or a reference position.

For example, the plane coordinates PL may be set by recognizing a position of the bucket of the excavator as PL1. The position of the bucket may be set as a reference position such as M, and coordinates for another object PL2 on the plane may be set based on this reference. A specific location at which the plane coordinates PL are set may include a guide line installed on a site for the manual surveying, a guide line marked on a ground of the construction site, and the like, such as PL3.

As illustrated in FIG. 5, the image recognition module 400 may set coordinates for an object and a certain area located around the excavator recognized by the 3D camera 110. Coordinates set for the object and the certain area by the image recognition module 400 may be defined as relative coordinates L1 (x1, y1, z1). For example, the relative coordinates L1 (x1, y, z1) may be set based on a position of the 3D camera 110. Alternatively, the relative coordinates L1 (x1, y1, z1) may be set based on a center of the excavator.

In particular, the surrounding space recognized by the 3D camera 110 may be reproduced in a 3D stereoscopic space, and specific coordinates (relative coordinates) for the reproduced 3D stereoscopic space may be set. The relative coordinates may include a three-dimensional structure of a construction site such as L21, guide lines installed on the construction site for manual surveying such as L22, a guide line displayed on the ground of the construction site, and the like.

In example embodiments, when the 3D camera 110 includes a stereo vision camera, the image recognition module 400 may photograph a surrounding area of the excavator through a photographing lens 112 having left and right lenses, and recognize the surrounding space of the excavator. For example, the image recognition module 400 may calculate a difference between central axis positions of left and right images obtained by the stereo vision camera to acquire 3D distance information thereby recognizing the surrounding space.

When setting coordinates (relative coordinates) for a specific space, an X direction may be defined as a right direction, a Y direction may be defined as a front direction, and a Z direction may be defined as a height direction based on the excavator. Similarly, an axis in the X direction may be defined as an X axis, an axis in the Y direction may be defined as a Y axis, and an axis in the Z direction may be defined as a Z axis. Accordingly, when specifying positions for the surrounding space of the excavator, the positions can be expressed as in a following equation (1).

P(X, Y, Z) equation (1)

As illustrated in FIGS. 6 and 7, in example embodiments, the image recognition module 400 may set a maximum working radius of the excavator with respect to the image captured by the 3D camera 110 and a three-dimensional space. The coordinates (relative coordinates) for the space set by the image recognition module 400 may include the maximum working radius.

In example embodiments, three-dimensional points representing the working radius of the excavator may be set. The three-dimensional points includes the maximum working radius P1, P2 of the excavator, ⅔ of the maximum working radius P3, P4, and ⅓ of the maximum working radius P5, P6 displayed on a two-dimensional image. Alternatively, the three-dimensional points may include the maximum working radius P1, P2 of the excavator, ⅔ of the maximum working radius P3, P4, and ⅓ of the maximum working radius P5, P6 set in the three-dimensional space recognized through the 3D camera 110.

For example, three pairs of points P1, P2, P3, P4, P5, P6 may be located between from a center of caterpillar wheels provided on both sides of the lower travelling body of the excavator to the maximum working radius of the excavator.

Each of the points P1, P2, P3, P4, P5, P6 may be expressed in three-dimensional coordinates as shown in following equations. Specifically, with respect to the excavator, X may indicate a right direction, Y may indicate a front, and Z may indicate a height.

1) the maximum working radius

(P₅)(X+D_{X}, Y+D_{Y}, Z−H), P₆(X−D_{X}, Y+D_{Y}, Z−H)

2) ⅔ of the maximum working radius

$${P}_{3} ( X + {D}_{X} , Y + \frac{2 {D}_{Y}}{3} , Z - H ) , {P}_{4} ( X - {D}_{X} , Y + \frac{2 {D}_{Y}}{3} , Z - H )$$

3) ⅓ of the maximum working radius

$${P}_{1} ( X + {D}_{X} , Y + \frac{{D}_{Y}}{3} , Z - H ) , {P}_{2} ( X - {D}_{X} , Y + \frac{{D}_{Y}}{3} , Z - H )$$

Here, Dx is a distance from the center of the excavator to the center of the caterpillar wheel, Dy is the maximum working radius of the excavator, and H is a distance from the center of the excavator to the ground.

In example embodiments, the coordinate conversion module 500 may receive data of position coordinates from the image recognition module 400 and the position information receiving device 120.

The coordinate conversion module 500 may receive the reference coordinates L2 (x2, y2, z2) corresponding to a position of the excavator obtained by the position information receiving device 120. For example, the position information receiving device 120 may determine the position by using the Global Navigation Satellite System (GNSS). Therefore, unlike the relative coordinates L1 (x1, y1, z1) received from the image recognition module 400 or the coordinates derived by analyzing the image acquired from the 3D camera 110, the reference coordinates L2 (x2, y2, z2) obtained from the position information receiving device 120 may be coordinates obtained from the outside, that is, geographic coordinates.

As illustrated in FIG. 8, the coordinate conversion module 500 may correct by axis transformation of the relative coordinates L1 that are set for the surrounding space of the excavator by the image recognition module 400. The coordinate conversion module 500 may perform the axis transformation along the X-axis, Y-axis, and Z-axis. The coordinate conversion module 500 may acquire a corrected relative coordinate L (x1′, y1′, z1′) according to the axis conversion.

For example, the coordinate conversion module 500 may receive data on a degree of axis transformation required for axis transformation of the relative coordinates L1 from a bucket inclination angle sensor, an arm inclination angle sensor, a boom inclination angle sensor, a turning angle sensor, a horizontal sensor, etc.

The coordinate conversion module 500 may convert the relative coordinates L1 (x1, y1, z1) by the axis transformation with respect to the X-axis, Y-axis, and Z-axis of the excavator. The coordinate conversion module 500 may perform the correction in consideration of a rotational direction of the upper swinging body of the excavator, an inclination change of the excavator depending on a condition of a ground, an inclination angle of the bucket, arm, boom, etc. The coordinate conversion module 500 may correct the relative coordinates L1 (x1, y1, z1) differently according to a type of the construction machinery 10.

The concept of Euler angle may be used to reflect the axis transformation. Specifically, X-axis rotation angle, Y-axis rotation angle and Z-axis rotation angle expressing the axis transformation received from the image recognition module 400 may be expressed as θRoll, θPitch, and θYaw. The point P reflecting the axis transformation may be derived through a following equation (2).

$$P ( \frac{X}{sin {θ}_{Roll}} , Y ⋆ cos {θ}_{pitch} , Z ) \qquad equation ( 2 )$$

Here, the X-axis rotation angle is θRoll, the Y-axis rotation angle is θPitch, and the Z-axis rotation angle is θYaw.

Accordingly, in the present disclosure, it may be possible to accurately grasp an actual working radius by reflecting the axis transformation for each point indicating the working radius of the excavator,

Furthermore, when the upper swinging body of the excavator rotates for excavation work, the position of the 3D camera 110 installed on the excavator may be changed. The coordinate conversion module 500 may reset the position of the excavator obtained through the image recognition module 400 in consideration of the degree of rotation with respect to the upper swinging body of the excavator. When another 3D camera 110 or other sensors are installed on the lower traveling body, the upper swinging body, an engine, the boom, the arm and the bucket of the excavator, the coordinate conversion module 500 may correct the position coordinate of the excavator in consideration of the specific position of the 3D camera 110 or the other sensors.

The three-dimensional coordinates TL (x3, y3, z3) which mean a final coordinate data may be expressed by following Equation (3) or Equation (4).

TL(x3, y3, z3)=L1(x1, y1, z1)+L2(x2, y2, z2) equation (3)

TL(x3, y3, z3)=L1(x1′, y1′, z1′)+L2(x2, y2, z2) equation (4)

The three-dimensional coordinates TL (x3, y3, z3) may be defined as data of final coordinates obtained by converting the relative coordinates L1 (x1, y1, z1) or the relative coordinates L (x1′, y1′, z1′) corrected through axis transformation based on the reference coordinates L2 (x2), y2, z2) by equation (3) or equation (4). The coordinate conversion module 500 may derive the three-dimensional coordinates TL (x3, y3, z3) as absolute coordinates by performing coordinate transformation of the relative coordinates L1 (x1, y1, z1) or the corrected relative coordinates L (x1′, y1′, z1′) based on the reference coordinate L2 (x2, y2, z2) obtained by the position information receiving device 120.

In particular, the reference coordinates L2 (x2, y2, z2) may be absolute coordinates indicating the position of the excavator, and the relative coordinates L (x1′, y1′, z1′) or the relative coordinates L (x1′, y1′, z1′) obtained through correction may be the relative coordinate indicating the position of the surrounding space of the excavator. The control system 100 may determine an overall position and coordinates of the excavator and the surrounding space of the excavator from the three-dimensional coordinates TL (x3, y3, z3).

In example embodiments, the coordinate conversion module 500 may correct the relative coordinates L1 (x1, y1, z1) set for the surrounding space of the excavator obtained by the image recognition module 400 by axis transformation in consideration of the maximum working radius of the excavator. The coordinate conversion module 500 may perform the axis transformation along the X-axis, Y-axis, and Z-axis. The data on the axis transformation may include a rotational direction of the excavator, a degree of inclination, and the like obtained through sensors provided in the excavator.

The coordinate conversion module 500 may link the three-dimensional coordinates TL (x3, y3, z3) including the reference coordinates L2 (x2, y2, z2) and the relative coordinates L1 (x1, y1, z1) with plane coordinates PL obtained from the image IM captured through the 3D camera 110. Specifically, when the object and area recognized in the three-dimensional coordinate TL and the same object and area recognized in the plane coordinate PL exist, and the coordinate conversion module 500 may connect them with each other to represent the same coordinates. The three-dimensional coordinates TL represented in 3D may be matched with the plane coordinates PL represented in 2D may be matched with each other to be displayed on the screen to the driver.

The coordinate conversion module 500 may convert the three-dimensional coordinates TL recognized as coordinates in space using a camera matrix to be connected with the plane coordinates PL. The camera matrix may be expressed by following Equation (5).

$$S ( \begin{matrix}x \\ y \\ 1\end{matrix} ) = ( \begin{matrix}{f}_{x} & {skew}_{c} {f}_{x} & {c}_{x} \\ 0 & {f}_{y} & {c}_{y} \\ 0 & 0 & 1\end{matrix} ) ( \begin{matrix}{X}_{c} \\ {Y}_{c} \\ {Z}_{c}\end{matrix} ) \qquad Equation ( 5 )$$

Here, fx is an x-axis plane coordinate focal length, fy is a y-axis plane coordinate focal length, Cx is an x-axis plane coordinate principal distance, Cy is ay-axis plane coordinate, and skewcfx is an asymmetry coefficient.

All coordinate information converted by the coordinate conversion module 500 may be transmitted to the control device 300. As illustrated in FIG. 9A, the display device 310 of the control device 300 may be installed in the driver's seat of the excavator and display the image having the three-dimensional coordinate information TL (x3, y3, z3) on the screen. The control device 300 may link the coordinate information with design drawing data input from an outside. The controller 320 of the control device 300 may control the movement of the excavator through the coordinate information. Alternatively, as illustrated in FIG. 9B, the display device 310 of the control device 300 may display the image having the three-dimensional structure L21 linked with the design drawing data or the guide line L22 installed for the manual surveying on the screen.

As described above, the control system 100 may photograph the surrounding image of the construction machinery 10 by using the 3D camera 110, recognize the relative coordinates L1 for the surrounding space, to obtain relative coordinate data for the surrounding space of the construction machinery 10, acquire absolute coordinate data for the position of the construction machinery 10 through the position information receiving device 120, and reflect the absolute coordinate data in the relative coordinate data to acquire 3D image data. By using the obtained 3D image data, it may be possible to interwork with the control device 300 such as the machine guidance or the machine control, and it may be possible to enable more precise and accurate construction work.

Hereinafter, a method of providing a working guide line using the control system of the construction machinery in FIG. 1 will be explained.

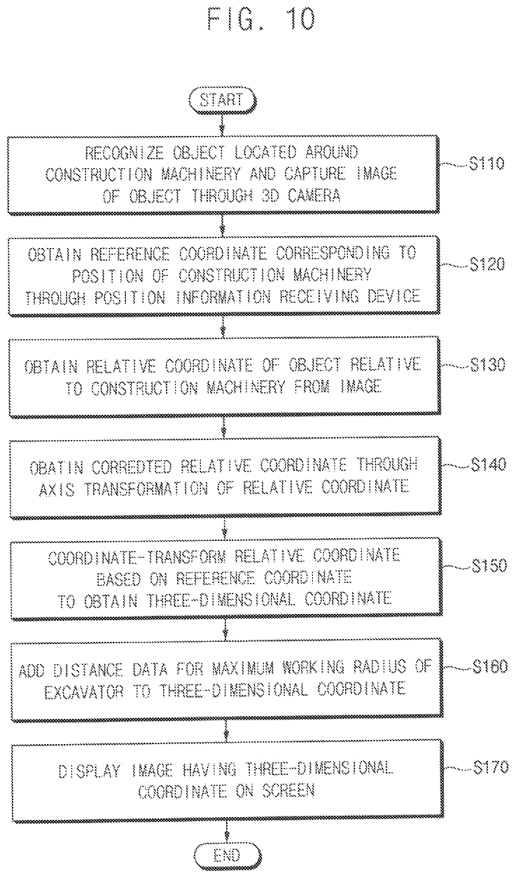

FIG. 10 is a flow chart illustrating a method of providing a working guide line for construction machinery in accordance with example embodiments.

Referring to FIGS. 1 to 10, first, an object located around construction machinery 10 may be recognized, and an image of a surrounding space of the construction machinery may be captured by 3D camera 110 (S110).

In example embodiments, a distance from the construction machinery 10 to a specific object or a certain area may be measured through the 3D camera 110. In addition, the 3D camera 110 may capture the surrounding space as an image. The 3D camera 110 may recognize a space with respect to the object or the certain area located around the construction machinery 10 by measuring the distance from the 3D camera 110 or the construction machinery 10 to the object or the certain area. Distance data and images for the surrounding space recognized through the 3D camera 110 may be transmitted to the image recognition module 400. For example, the 3D camera 110 used in the step S110 of recognizing the object through the 3D camera and capturing the image may include a stereo vision camera.

In example embodiments, recognizing the object and capturing the image may include classifying the captured image, storing it as a data set, and learning the object from the data set. Learning the object from the data set may include analyzing and learning the object through deep learning in the image determiner of the data processing device 200.

In example embodiments, recognizing the object and capturing the image may further include extracting a guide line installed for a three-dimensional structure or manual surveying as a feature point (keypoint) through semantic segmentation from the data set. The data processing device 200 may label and classify the feature point for the three-dimensional structure or the guide line.

Then, reference coordinates L2 corresponding to a position of the construction machinery 10 may be obtained through the position information receiving device 120 (S120).

In example embodiments, the position information of the construction machine 10 may be obtained by using the position information receiving device 120. The position of the construction machinery 10 obtained by the position information receiving device 120 may be defined as the reference coordinates L2 (x2, y2, z2). The position coordinates of the construction machinery 10 recognized through the position information receiving device 120 may be transmitted to the coordinate conversion module 500. For example, the position information receiving device 120 may include a receiver of a Global Navigation Satellite System (GNSS). The global navigation satellite system may be a series of systems for locating a target and providing visual information using a plurality of artificial satellites and receiving equipment on a ground.

Then, relative coordinates L1 of the object relative to the construction machinery 10 may be obtained from the image (S130), corrected relative coordinates may be obtained by axis transformation of the relative coordinates to reflect rotation angles with respect to X-axis, Y-axis, and Z-axis of the construction machinery (S140).

In example embodiments, coordinates of the object and a certain area located around the construction machinery 10 recognized by the 3D camera 110 may be obtained. This step may be performed in the image recognition module 400. Coordinates set for the object and the certain area by the image recognition module 400 may be defined as the relative coordinates L1 (x1, y1, z1). The relative coordinates L1 (x1, y1, z1) may be transmitted to the coordinate conversion module 500. For example, the relative coordinates L1 (x1, y1, z1) may be set based on a position of the 3D camera 110. Alternatively, the relative coordinates L1 (x1, y1, z1) may be set based on a center of the construction machinery 10.

In particular, the surrounding space recognized by the 3D camera 110 may be reproduced in a 3D stereoscopic space, and specific coordinates (relative coordinates) for the reproduced 3D stereoscopic space may be set. The set coordinates (relative coordinates) may include a three-dimensional structure of a construction site, guide lines installed on the site for manual surveying, guide lines displayed on the ground of the construction site, etc.

In example embodiments, when the 3D camera 110 includes a stereo vision camera, the image recognition module 400 may photograph a surrounding area of the excavator through the photographing lens 112 having left and right lenses, and recognize the surrounding space of the excavator. For example, the image recognition module 400 may calculate a difference between central axis positions of left and right images taken by the stereo vision camera to acquire 3D distance information thereby recognizing the surrounding space by.

In example embodiments, the relative coordinates L1 (x1, y1, z1) set for the surrounding space of the construction machinery 10 may be corrected by axis transformation reflecting angles of rotation with respect to X-axis, Y-axis, and Z-axis of the construction machinery 10. This correction may be performed in the coordinate conversion module 500. The coordinate conversion module 500 may acquire the corrected relative coordinates L (x1′, y1′, z1′) according to the axis transformation.

When the construction machinery 10 is an excavator, the coordinate conversion module 500 may receive data on a degree of axis transformation required for axis transformation of the relative coordinates L1 (x1, y1, z1) from a bucket inclination angle sensor, an arm inclination angle sensor, a boom inclination angle sensor, a turning angle sensor, a horizontal sensor, etc.

The coordinate conversion module 500 may correct the relative coordinates L1 (x1, y1, z1) differently according to a type of the construction machinery 10. For example, when the construction machine 10 is an excavator, the coordinate conversion module 500 may convert the relative coordinates L1 (x1, y1, z1) by the axis transformation of the X-axis, Y-axis, and Z-axis of the excavator. The coordinate conversion module 500 may correct the relative coordinates L1 (x1, y1, z1) in consideration of a rotational direction of the upper swinging body, an inclination change of the excavator depending on a condition of the ground, an inclination angle of the bucket, arm, boom, etc. of the excavator.

Then, three-dimensional coordinates TL may be obtained by performing coordinate transformation of the relative coordinates L1 based on the reference coordinates L2 (S150), and distance data for a maximum working radius may be added to the three-dimensional coordinates (S160).

In example embodiments, the three-dimensional coordinates TL (x3, y3, z3) may be derived as absolute coordinates by performing coordinate transformation of the relative coordinates L1′ (x1′, y1′, z1′) obtained through correction based on the reference coordinates L2 (x2, y2, z2) obtained by the position information receiving device 120. The three-dimensional coordinates TL may be defined as data of final coordinates that interconnects the relative coordinates L1′ (x1′, y1′, z1′) with the reference coordinates L2 (x2, y2, z2).

In particular, the reference coordinates L2 (x2, y2, z2) may be absolute coordinates indicating the position of the excavator, and the relative coordinates L (x1′, y1′, z1′) may be the relative coordinates indicating the position of the surrounding space of the excavator. The control system 100 may determine an overall position and coordinates of the excavator and the surrounding space of the excavator from the three-dimensional coordinates TL (x3, y3, z3).

In example embodiments, when the construction machinery 10 is an excavator, the image recognition module 400 may set the maximum working radius of the excavator with respect to the image captured by the 3D camera 110 and a three-dimensional space. The coordinates (relative coordinates) for the space set by the image recognition module 400 may include the maximum working radius.

Then, the image having the three-dimensional coordinates may be displayed on the screen (S170).

In example embodiments, all coordinate information converted by the coordinate conversion module 500 may be transmitted to the control device 300. The control device 300 may link the three-dimensional coordinates TL with design drawing data input from an outside. The design drawing data may include work contents of the excavator used at a construction site, a work area, a survey point, specific dimensions, necessary materials, and the like. The control device 300 may display a 3D image having the three-dimensional coordinates TL on a screen such as a monitor through the display device 310. The control device 300 may control the operation of the excavator through the controller 320 using geographic coordinate information including the three-dimensional coordinates TL.

For example, when the control device 300 performs a machine guidance function, the control device 300 may display the image having the three-dimensional coordinates TL on the screen through the display device 310. In addition, when the excavator deviates from a preset coordinates (the working area), the control device 300 may provide information to the driver by sending a warning signal or displaying it on the screen. Alternatively, when the control device 300 performs a machine control function, the control device 300 may control the excavator so as not to exceed the working radius defined by preset coordinates, thereby increasing a precision of a work of the excavator.

As described above, in the method of providing the working guide line for the construction machinery, the image of the object may be obtained through a 3D camera (S110), the reference coordinates and the relative coordinates may be obtained (S120, S130), and the three-dimensional coordinates may be obtained by converting the relative coordinates into absolute coordinates based on the reference coordinates (S150). Through the three-dimensional coordinate data obtained in this way, it may be possible to interwork with the control device 300 such as machine guidance or machine control (S170), and it may be possible to enable more precise construction work.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of the present disclosure. Accordingly, all such modifications are intended to be included within the scope of example embodiments as defined in the claims.

What is claimed is:

1. A control system for construction machinery, the control system comprising:
a 3D camera configured to recognize an object located around the construction machinery and capture an image of the object;
a position information receiving device configured to obtain a reference coordinate corresponding to a position of the construction machinery;
a data processing device configured to recognize the relative coordinate of the object relative to the construction machinery from the image, and convert the relative coordinates based on the reference coordinate to obtain a three-dimensional coordinate; and
a control device configured to display the image having the three-dimensional coordinates on a screen.

2. The control system of claim 1, wherein the data processing device includes:
an image recognition module configured to extract the relative coordinate of the object from the image; and
a coordinate conversion module configured to coordinate-transform the relative coordinate of the object based on the reference coordinate to obtain the three-dimensional coordinate.

3. The control system of claim 2, wherein the coordinate conversion module obtains a corrected relative coordinate through axis transformation of the relative coordinate, the axis transformation reflecting rotation angles for X-axis, Y-axis, and Z-axis of the construction machinery, and converts the corrected relative coordinates into an absolute coordinate to obtain the three-dimensional coordinate.

4. The control system of claim 1, wherein the construction machinery is an excavator.

5. The control system of claim 4, wherein the data processing device adds distance data for a maximum working radius of the excavator to the three-dimensional coordinates, and the control device displays the distance data on the screen.

6. The control system of claim 1, wherein the control device displays design drawing data of a construction site in association with the three-dimensional coordinate on the screen.

7. The control system of claim 6, wherein the data processing device extracts three-dimensional structure or a guide line installed for manual surveying from the image, the control device interlocks the extracted three-dimensional structure or the guide line installed for the manual surveying with the design drawing data.

8. The control system of claim 2, wherein the image recognition module includes an image determiner configured to classify the image and store the image as a data set and recognize the object in the image using an algorithm previously learned from the data set.

9. The control system of claim 8, wherein the image determiner extracts a three-dimensional structure or a guide line installed for manual surveying as a feature point from the data set.

10. A control system for construction machinery, the control system comprising:
a 3D camera configured to recognize an object located around the construction machinery and capture an image of the object; and
an image recognition module configured to extract a relative coordinate of the object from the image,
wherein the image recognition module includes an image determiner configured to classify the image and store the image as a data set and recognize the object in the image using an algorithm previously learned from the data set, and
the image determiner extracts a three-dimensional structure or a guide line installed for manual surveying as a feature point from the data set.

11. A method of providing a working guide line for construction machinery, the method comprising:
recognizing an object located around the construction machinery and capturing an image of the object through a 3D camera,
obtaining a reference coordinate corresponding to a position of the construction machinery through a position information receiving device,
obtaining a relative coordinate of the object relative to the construction machinery from the image,
coordinate-transforming the relative coordinate based on the reference coordinate to obtain a three-dimensional coordinate, and
displaying the image having the three-dimensional coordinate on the screen.

12. The method of claim 11, further comprising:
obtaining a corrected relative coordinate through axis transformation of the relative coordinate, the axis transformation reflecting rotation angles for X-axis, Y-axis, and Z-axis of the construction machinery with respect to the relative coordinates, and
wherein obtaining the three-dimensional coordinate includes converting the corrected relative coordinate into an absolute coordinate based on the reference coordinate.

13. The method of claim 11, wherein the construction machinery is an excavator.

14. The method of claim 13, further comprising:
adding distance data for a maximum working radius of the excavator to the three-dimensional coordinate,
wherein displaying the image on the screen includes displaying the image including the distance data on the screen.

15. The method of claim 11, further comprising:
displaying design drawing data of a construction site in association with the three-dimensional coordinate on the screen.

16. The method of claim 11, wherein obtaining the relative coordinate includes classifying the image and storing the image as a data set and recognizing the object in the image using an algorithm previously learned from the data set.

17. The method of claim 16, wherein obtaining the relative coordinate further includes extracting a three-dimensional structure or a guide line installed for manual surveying as a feature point from the data set.
